(19) United States
(12) Patent Application Publication
(10) Pub. No.: US 2012/0014545 A1
(43) Pub. Date: Jan. 19, 2012

(54) Hearing Instrument and Method for Providing Hearing Assistance

(75) Inventor: Stefan Menzl, Jona (CH)

(73) Assignee: ADVANCED BIONICS AG, Zug (CH)

(21) Appl. No.: 13/259,342

(22) PCT Filed: Mar. 24, 2009
(86) PCT No.: PCT/EP2009/053451

§ 371 Date: Sep. 23, 2011

(51) Int. Cl. H04R 25/00

(52) U.S. Cl. 381/315; 381/326

(57) ABSTRACT

There is provided a hearing instrument comprising an audio signal processing unit for processing audio signals and means for mechanically applying acoustic waves to the blood in a blood vessel of a user in the audible frequency range according to the processed audio signals in order to stimulate the user's hearing sense.

The invention relates to a hearing instrument comprising an audio signal processing unit for processing audio signals and means for stimulating the user's hearing sense according to the processed audio signals. The invention also relates to a method for providing hearing assistance to a user.

Implantable hearing instruments usually are based on direct electric stimulation of the cochlear (cochlear implants) or on mechanical stimulation at a position in the vibration transfer path between the eardrum and the cochlea. Such implantable solutions require substantial surgery at the head, for example, providing access to fluids close to the brain. Moreover, space for an implant is significantly limited at the skull, resulting in severe requirements with regard to the size of the devices and the size of the battery.

Further, hearing instruments using bone conduction between the skull and the inner ear are known from experiments using stimulation of the perilymph fluid and at the vestibular system.

WO 2005/072168 A2 relates to a system for improving hearing in patients suffering from hearing loss, wherein a vibration stimulus in the form of high frequency noise or ultra sound at frequencies of 2 kHz to 5 MHz is applied to the head of the patient in order to stimulate the patient's cortex and/or the patient's inner ear in order to prevent or reverse the deleterious programming of high-frequency sensing and processing neurons to lower frequencies. The vibration stimulus may be applied by conduction through bones of the head, through fluids, such as blood and tissues of the head and neck or through bone conduction and fluid conduction. The vibration stimulus is applied by using a vibrator applied to the head of the patient or fluid-filled headphones or a fluid-filled neck ring applied to the head of the patient.

It is an object of the invention to provide for a partially implantable hearing instrument which encounters relatively mild restrictions with regard to space and which may be applied to the patient in a relatively simple and little invasive manner. It is also an object of the invention to provide for a corresponding method for providing hearing assistance to a patient.

According to the invention, these object is are achieved by a hearing instrument as defined in claim 1 and a method as defined in claim 27.

The invention is beneficial in that, by mechanically applying acoustic waves to the blood in a blood-vessel of the user in the audible frequency range according to the audio signals processed by the audio signal processing unit in order to stimulate the user's hearing sense, stimulation of the user's hearing sense may be performed at locations other than the user's ear or skull, such as at a leg or an arm or at the chest or the neck, where surgery may be less critical than at the user's head and where there is more space than at the user's ear.

Preferably, the means for applying acoustic waves comprise a vibration element implanted within the blood vessel and a driver arrangement located outside the blood vessel for driving the vibration element. Preferably, the vibration element is located within a sleeve element implanted within the blood vessel, such as a stent, and the vibration element comprises a permanent magnet which is driven by a coil arrangement of the driver arrangement. The coil arrangement may coaxially surround the blood vessel at an implanted position or at a position outside the user's body. Alternatively, the coil arrangement may be oriented parallel to the blood vessel at an implanted position or at a position outside the user's body.

Usually, the hearing instrument comprises a microphone arrangement. According to one embodiment, the microphone arrangement, the audio signal processing unit and the driver arrangement form part of an external unit to be worn at the user's body. According to an alternative embodiment, the microphone arrangement and the audio signal processing unit form part of an external unit to be worn at or close to the user's head, wherein the driver arrangement forms part of an implantable unit, wherein the external unit comprises means for wireless transmission of the processed audio signals, and wherein the implantable unit comprises means for receiving the processed audio signals. According to another alternative embodiment, the microphone arrangement and the audio signal processing unit form part of a first external unit to be worn at or close to the user's head, wherein the driver arrangement forms part of a second external unit to be worn at the user's body close to the vibration element, wherein the first external unit comprises means for wireless transmission of the processed audio signals and wherein the second external unit comprises means for receiving the processed audio signals.

Further preferred embodiments are defined in the dependent claims.

Hereinafter, examples of the invention will be illustrated by reference to the attached drawings, wherein:

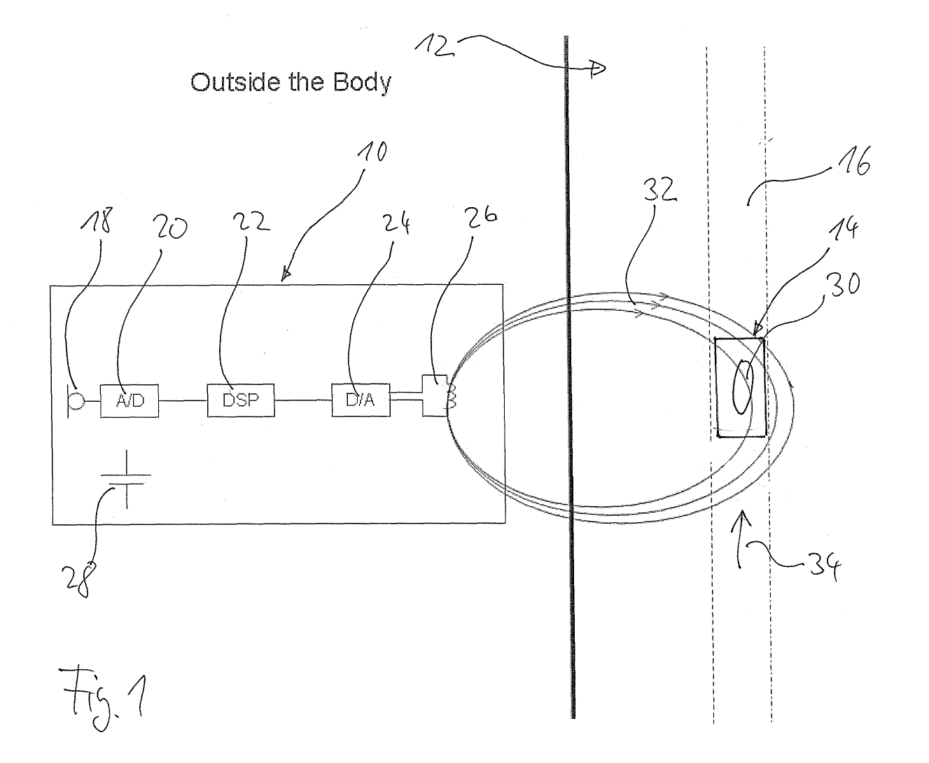

FIG. 1 is a block diagram of a hearing instrument according to a first embodiment of the invention;

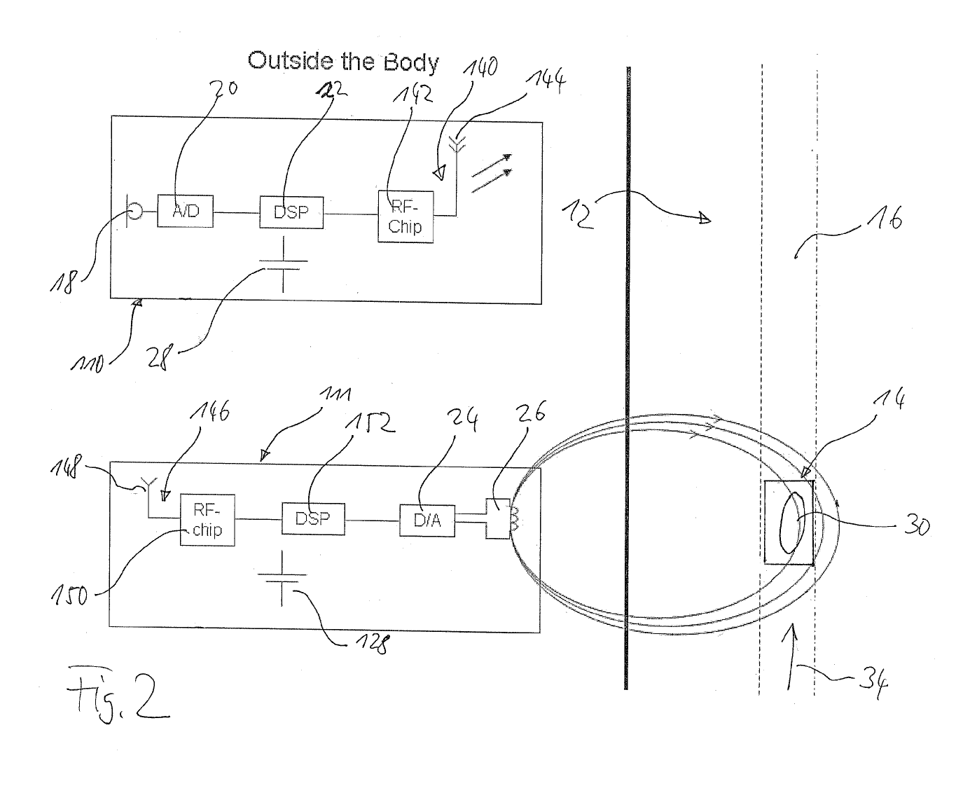

FIG. 2 is a block diagram of a hearing instrument according to a second embodiment of the invention;

FIG. 3 is a block diagram of a hearing instrument according to a third embodiment of the invention;

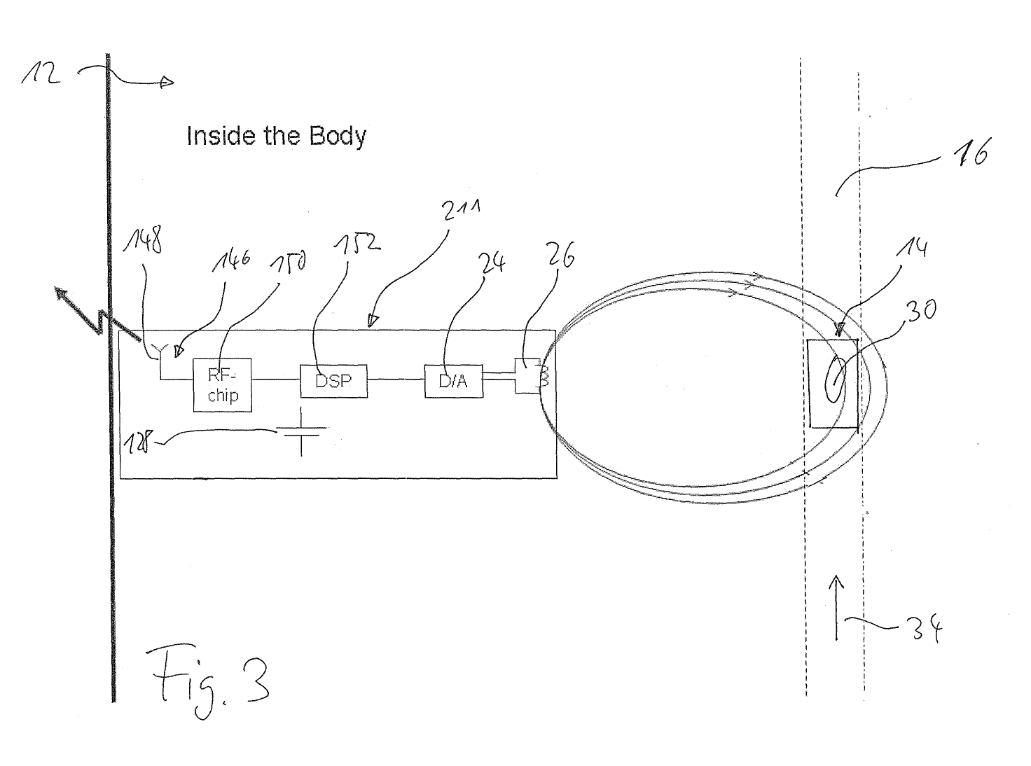

FIG. 4 is a schematic view of a first embodiment of an output transducer to be used with in invention;

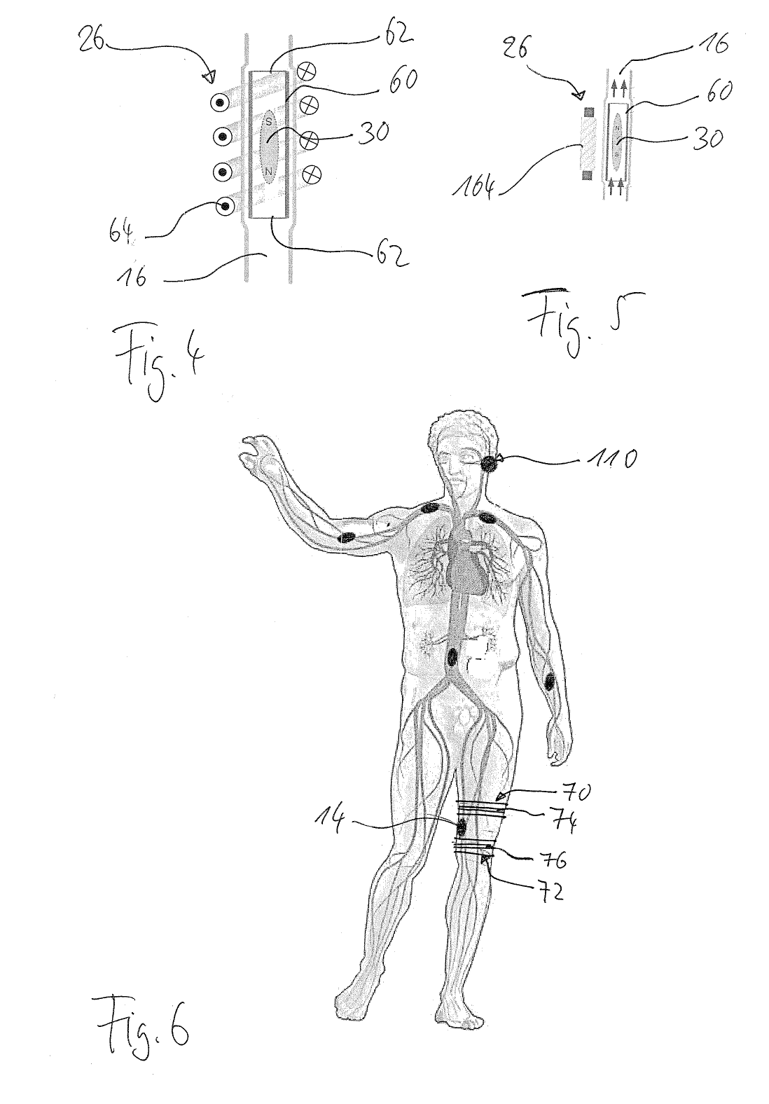

FIG. 5 is a schematic view of a second embodiment of an output transducer to be used in the invention; and

FIG. 6 is a schematic representation of a person wearing a hearing instrument according to the invention.

FIG. 1 is a block diagram of a first example of a hearing instrument according to the invention, which comprises an external unit 10 to be worn outside the user's body 12 and an implantable actuator unit 14 which is implanted within a blood vessel 16. The external unit 10 comprises a microphone arrangement 18 for capturing audio signals from ambient sound, an analog to digital converter (ADC) 20 for the audio signals, an audio signal processing unit 22 for processing the audio signals into a driver signal for an output transducer, a digital to analog converter (DAC) for the processed audio signals, a coil arrangement 26 and a battery 28. The microphone arrangement may comprise at least two spaced-apart microphones for acoustic beamforming. The implantable actuator unit 14 comprises a magnetic vibration element 30 which is driven by the coil arrangement 26 via a magnetic field 32 created by the coil arrangement 26 according to the processed audio signals. The vibration element 30 is oriented coaxial with regard to the blood vessel 16 and is driven by the coil arrangement 26 in a manner so as to vibrate into and against the direction 34 of the blood flow within the blood vessel 16. Thereby the vibration element 30 creates pressure waves/acoustic waves in the blood flowing within the blood vessel 16 in the audible frequency range according to the processed audio signals provided by the audio signal processing unit 22. The waves created by the vibration element 30 finally reach the user's cochlea and there create a hearing impression according to the audio signals captured by the microphone arrangement 18.

In FIG. 2 an alternative embodiment of the hearing instrument is shown, wherein the external unit 10 of FIG. 1 is split into two parts, namely a first external unit 110 which is worn at or close to the user's head, preferably at or behind the user's ear, and a second external unit 111 which is worn close to the implantable actuator unit 14. The first external unit comprises the microphone arrangement 18, the ADC 20, the audio signal processing unit 22, a battery 28 and a transmission unit 140 for wireless transmission of the processed audio signals to the second external unit 111. The transmission unit 140 comprises a radio frequency transmitter 142 and an antenna 144. The second external unit 111 comprises a receiver unit 146 comprising an antenna 148 and a radio frequency receiver 150, a signal processing unit 152, a battery 128, the DAC 24 and the coil arrangement 26. With the embodiment of FIG. 2 the microphone arrangement 18 can be located at the optimal place, namely at the user's ear, while the driver, namely the coil arrangement 26, for the implantable actuator unit 14 can be located close to the implantable actuator unit 14.

Another alternative embodiment is shown in FIG. 3, wherein the second external unit 111 of FIG. 2 is designed as an implantable unit 211 which comprises the receiver unit 146, the signal processing unit 152, the DAC 24, the coil arrangement 26 and the battery 128. With this embodiment, the coil arrangement 26 can be located as close as possible to the vibration element 30. The wireless link from the external unit 110 in this case is a transcutaneous wireless link.

In FIG. 4 an example of the vibration element 30 and the coil arrangement 26 is schematically shown. The vibration element 30 is located within a sleeve element 60 implanted within the blood vessel 16. The sleeve element 60 may be a stent which slightly widens the blood vessel in the radial direction. Preferably, the sleeve 60 is provided with retention means 62 at both ends of the sleeve element 60 in order to retain the vibration element 30 within the sleeve element 60. For example, the two ends of the stent may be closed by a bar, cross bar or grid to prevent the vibration element 30 from being washed away by the blood while the stimulation coils are turned off. Alternatively, the actuator unit 14 may be provided with magnetic means for retaining the vibration element 30 within the sleeve element 60. In this case, one or multiple magnets (not shown) fixed to the actuator unit 14 may be provided which hold the vibration element 30 in place, while the stimulation coils are disabled. Preferably, the sleeve 60 is designed for guiding the vibration element 30, with the vibration element 30 being aligned within the sleeve element 60. According to FIG. 4 the vibration element 30 has an elongate shape, namely an ellipsoid shape, and it is oriented coaxial with regard to the blood vessels 16. The vibration element 30 is designed in such a manner that the mean blood flow is reduced as little as possible. The vibration element 30 is at least magnetically conducting; preferably it comprises a permanent magnet.

In the embodiment shown in FIG. 4 the coil arrangement 26 consists of an implanted coil 64 which is wound around the blood vessel 16 by implantation. When an alternating current/voltage is applied to the coil 64, an alternating magnetic field is created which moves the vibration element 30 back and forth within the blood vessel 16, thereby creating acoustic waves in the blood.

According to an alternative embodiment, the coil 64 may be an external coil which is wound around that part of the body in which the blood vessel 16 is located. For example, if the blood vessel 16 is the femural artery, the coil 64 would be wound around the thigh. According to a modified embodiment, the coil arrangement 26 may consists of two Helmholtz coils 70, 72 (see FIG. 6), which are located axially spaced with regard to the vibration element 30 at each of the ends of the vibration element 30. The coils 70, 72 (or the coil 64) may be integrated within straps 76, 78 surrounding the respective part of the body. The two Helmoltz coils 70, 72 may also be collapsed into one in an alternative embodiment.

In particular, the coil arrangement 26, or the respective external unit 10, 111 carrying the coil arrangement 26, may be fixed at the neck, the chest, a leg or an arm of the user, depending on the implantation position of the vibration element 30.

According to the alternative embodiment shown in FIG. 5, the coil arrangement 26 does not surround the vibration element 30, but rather is oriented parallel to the blood vessel 16 and the vibration element 30. In FIG. 5 an example is shown wherein a coil 164 is oriented parallel to the vibration element 30 at an implanted position. Alternatively, the coil 164 may be located outside the body close to the position of the vibration element 30. In this case, the coil 164 (and the respective external units 10, 111) may be fixed by respective straps at the correct position at the user's body.

While surgery is easier when it is not necessary to wind the coil around the blood vessel 16, in the embodiment of FIG. 5 it is necessary to prevent the vibration element 30 from rotating around an axis perpendicular to the paper plane of FIG. 5. This goal can be achieved, for example, by the shown elongate shape of the vibration element 30 and/or a particular shape of the implantable actuator part 14.

In FIG. 6 several examples of locations of the vibration element 30 are schematically shown.

In general, there may be more than one output transducer for blood stimulation, wherein each output transducer (comprising, for example, a vibration element 30 in a sleeve 60 and a stimulation coil 26 according to one of the embodiments discussed above) may located at a position in the user's body different from that of the other(s). Each output transducer may be used for stimulation in a specific frequency range. For example, a first output transducer located at first position (e.g. at the aorta) may be used for blood stimulation at high audio frequencies and a second output transducer located at a second position (e.g. at the carotid artery) may be used for blood stimulation at lower audio frequencies.

Further, the hearing instrument may comprise at least one conventional output transducer, such as a cochlea implant or a middle ear implant, in addition to the blood stimulation output transducer(s). Also in this case different output transducers, i.e. the conventional one and the blood stimulation output transducer(s), may be used for stimulation in different audio frequency ranges.

1. A hearing instrument, comprising;
an audio signal processing unit for processing audio signals; and
means for mechanically applying acoustic waves to blood in a blood vessel of a user in an audible frequency range according to the processed audio signals in order to stimulate a hearing sense of the user.

2. The hearing instrument of claim 1, wherein the means for applying acoustic waves comprise a vibration element implanted within the blood vessel and a driver arrangement to be located outside the blood vessel for driving the vibration element.

3. The hearing instrument of claim 2, wherein the vibration element is located within a sleeve element implanted within the blood vessel.

4. The hearing instrument of claim 3, wherein the sleeve element is provided at both ends with means for retaining the vibration element within the sleeve element.

5. The hearing instrument of claim 4, wherein the means for retaining the vibration element within the sleeve element comprise a grid or a bar.

6. The hearing instrument of claim 3, wherein the sleeve element is a stent.

7. The hearing instrument of claim 2, wherein the vibration element is magnetically conducting.

8. The hearing instrument of claim 7, wherein the vibration element comprises a permanent magnet.

9. The hearing instrument of claim 7, wherein the driver arrangement comprises a coil arrangement.

10. The hearing instrument of claim 9, wherein the coil arrangement is for coaxially surrounding the blood vessel at an implanted position.

11. The hearing instrument of claim 9, wherein the coil arrangement is for surrounding the blood vessel at a position outside the user's body.

12. The hearing instrument of claim 9, wherein the coil arrangement is for being oriented parallel to the blood vessel at an implanted position.

13. The hearing instrument of claim 9, wherein the coil arrangement is for being oriented parallel to the blood vessel at a position outside the user's body.

14. The hearing instrument of claim 11, wherein the coil arrangement comprises two Helmholtz coils to be located axially spaced with regard to the vibration element at or close to each of the ends of the vibration elements.

15. The hearing instrument of claim 11, wherein the hearing instrument comprises means for fixing the coil arrangement at least one of a neck of the user, a chest of the user, a leg of the user, or an arm of the user.

16. The hearing instrument of claim 15, wherein the fixing means comprise straps to be worn around at least one of the neck of the user, the chest of the user, the leg of the user, or an and the arm of the user.

17. The hearing instrument of claim 2, wherein the vibration element and the sleeve element are designed such that the vibration element is aligned within the sleeve element.

18. The hearing instrument of claim 17, wherein the sleeve element is for guiding the vibration element.

19. The hearing instrument of claim 17, wherein the vibration element has an elongate shape.

20. The hearing instrument of claim 19, wherein the vibration element has an ellipsoid shape.

21. The hearing instrument of claim 2, wherein the vibration element is for being oriented coaxial with regard to the blood vessel.

22. The hearing instrument of claim 21, wherein the vibration element is for moving parallel to the direction of a blood flow within the blood vessel.

23. The hearing instrument of claim 2, wherein the hearing instrument comprises a microphone arrangement for supplying audio signals to the audio signal processing unit.

24. The hearing instrument of claim 23, wherein the microphone arrangement, the audio signal processing unit and the driver arrangement form part of an external unit to be worn at the user's body.

25. The hearing instrument of claim 23, wherein the microphone arrangement and the audio signal processing unit form part of an external unit to be worn at or close to a head of the user, wherein the driver arrangement forms part of an implantable unit, wherein the external unit comprises means for wireless transmission of the processed audio signals and wherein the implantable unit comprises means for receiving the processed audio signals.

26. The hearing instrument of claim 23, wherein the microphone arrangement and the audio signal processing unit form part of a first external unit to be worn at or close to a head of the user, wherein the driver arrangement forms part of a second external unit to be worn at the user's body close to the vibration element, wherein the first external unit comprises means for wireless transmission of the processed audio signals and wherein the second external unit comprises means for receiving the processed audio signals.

27. A method for providing hearing assistance to a user, comprising:
generating audio signals;
processing said audio signals; and
mechanically applying acoustic waves to blood in a blood vessel of a user in the audible frequency range according to the processed audio signals in order to stimulate a hearing sense of the user.

28. The method of claim 27, wherein the blood vessel is an aorta, a femoral artery or a carotid artery.
